(19) United States
(12) Patent Application Publication
(10) Pub. No.: US 2007/0164979 A1
(43) Pub. Date: Jul. 19, 2007

(54) Video display driving method of LCD

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/653,874

(22) Filed: Jan. 17, 2007

(30) Foreign Application Priority Data
Jan. 18, 2006 (TW) 095101952

(51) Int. Cl. G09G 3/36

(52) U.S. Cl. 345/102

(57) ABSTRACT

A video display driving method of a liquid crystal display (LCD) receives a plurality of sets of video frame data for an LCD panel. The method transforms each set of the video frame data into a preset-voltage signal and a post-set-voltage signal for driving a plurality of pixels during a frame time. A light source brightness of a backlight module presents a first average brightness during a corresponding time when the preset-voltage signal is written into the pixel, and presents a second average brightness during a corresponding time when the post-set-voltage signal is written into the pixel. The second average brightness is greater than the first average brightness. In addition, when a dynamic brightness control is performed during at least one frame time, the driving method adjusts the second average brightness according to a result of the dynamic brightness control.

### BACKGROUND OF THE INVENTION

1. Field of Invention

The invention relates to a video display driving method of a display device and, in particular, to a video display driving method of a liquid crystal display (LCD).

2. Related Art

LCDs may be classified into a LCD for a typical display screen and a LCD for a television. In fact, the basic structures of the two kinds of LCDs are similar to each other except for some components, some circuits and the positions of some components.

Referring to FIG. 1, a conventional LCD mainly includes a liquid crystal display panel 1, a backlight module 2, a driving circuit 3 and a control circuit 4.

Referring to FIG. 1, the liquid crystal display panel 1 includes a liquid crystal layer 11, a color filter substrate 12, a transistor circuit substrate 13 and two polarizers 14 and 15. The liquid crystal layer 11 is disposed between the color filter substrate 12 and the transistor circuit substrate 13, and the polarizers 14 and 15 are respectively disposed on sides of the color filter substrate 12 and the transistor circuit substrate 13.

Also, the backlight module 2 of FIG. 1 mainly includes a lightbox 21 and a driver 22 for driving a light source. The lightbox 21 includes a plurality of light emitting elements 211 and a diffuser plate 212. In general, the light emitting element 211 may be a cold cathode fluorescent lamp (CCFL) or a light emitting diode (LED), the latter of which has been increasingly important recently. The driving circuit 3 is electrically connected to the liquid crystal display panel 1 and drives the liquid crystal display panel 1. Typically, the driving circuit 3 is mainly composed of a plurality of driving ICs and at least one driving circuit board.

The control circuit 4 controls the driving circuit 3 and thus the liquid crystal display panel 1. The control circuit 4 and the driver 22 are often disposed on the same side of the lightbox 21. The lightbox 21 is disposed adjacent to the liquid crystal display panel 1 so that the light source of the light emitting element 211 of the lightbox 21 may illuminate the liquid crystal display panel 1 and the light emitted from the light emitting element 211 is presented on a display surface 16 of the liquid crystal display panel 1.

In the above-mentioned video display driving method of the conventional LCD, some manufacturers have recently disclosed the technology of dynamic brightness control to decrease the power consumption. Dynamic brightness control increases the transmittance of the liquid crystal of the pixel corresponding to the video data during a video frame time, and decreases the brightness of the light emitting element of the pixel corresponding to the video data so as to maintain the brightness presented on the display surface. Consequently, the contrast of the low gray-scale frame can be increased and the power consumption of the backlight source can be reduced.

However, because the response time of the liquid crystal in the liquid crystal layer 11 is relatively long, motion pictures displayed on the display surface 16 of the liquid crystal display panel 1 are blurred when the video data is displayed under normal conditions. When the dynamic brightness control is added, the control of the transmittance of the liquid crystal has to be performed in conjunction with the adjustment of the brightness of the backlight source to present the correct video. So, the video frames presented to the user may have poor quality due to the response time of the liquid crystal, and/or because the brightness of the backlight source varies in real time variation.

To solve this problem, the manufacturer has developed a liquid crystal with a shorter response time. However, the liquid crystal with the shorter response time increases the difficulty of manufacturing the liquid crystal display panel 1. When the backlight source is always on, reducing the response time of the liquid crystal to eliminate the drawbacks of the distorted or blurred frame caused by the incorrect display data is not an efficient or effective method.

The influence of the response time of the liquid crystal on the video will be described with reference to FIGS. 2A to 2D. In FIG. 2A, a voltage signal V₁ is sequentially written into a pixel of the display surface 16 throughout two frame times. As shown in FIG. 2B, when the response time of the liquid crystal is longer, the liquid crystal corresponding to the pixel cannot immediately reach the steady state, so the transmittance (the curve depicted by the solid line in FIG. 2B) of the pixel during the first frame time T₁ cannot reach the transmittance Tr₁ corresponding to the voltage signal V₁, and even the transmittance of the pixel during the second frame time T₂ cannot completely reach the transmittance Tr₁ corresponding to the voltage signal V₁. In the case of using the liquid crystal with the longer response time, the transmittance (the curve depicted by the dashed line in FIG. 2B) of the pixel during the first frame time T₁ still cannot reach the transmittance Tr₁ corresponding to the voltage signal V₁, but the transmittance of the pixel can almost reach the transmittance Tr₁ corresponding to the voltage signal V₁ during the second frame time T₂. Correspondingly, as shown in FIG. 2C, if the light source of the light emitting element 211 with the illumination intensity L₁ is used, the brightness presented by the pixels on the display surface 16 is shown in FIG. 2D. Using the liquid crystal with the shorter response time can enable the pixel to reach the desired brightness more rapidly. However, if the display mode of the conventional LCD displays video continuously, and the number of control variables for performing the dynamic brightness control is increased then no matter how short the response time of the liquid crystal is, the conventional LCD still provides poor quality video in the video frame and thus poor quality to the user.

Thus, it is an important subject of the invention to provide a video display driving method of a LCD, which can improve the blurriness or prevent errors in display frame data when the LCD is performing the dynamical brightness control.

### SUMMARY OF THE INVENTION

In view of the foregoing, the invention is to provide a video display driving method of a LCD capable of effectively preventing poor quality video in a displayed frame when the backlight source brightness is dynamically adjusted.

To achieve the above, the invention discloses a video display driving method of a liquid crystal display (LCD). The LCD includes a liquid crystal display panel and a backlight module. The liquid crystal display panel has a plurality of pixels distributed over a display surface of the liquid crystal display panel. A light source of the backlight module is projected onto the display surface of the liquid crystal display panel. The liquid crystal display panel receives a plurality of sets of video frame data and transforms each of the sets of video frame data into a preset-voltage signal and a post-set-voltage signal for driving the pixels during a fame time. A light source brightness of the backlight module presents a first average brightness while the preset-voltage signal is written into at least one of the pixels and presents a second average brightness while the post-set-voltage signal is written into the pixel. The second average brightness is greater than the first average brightness. The method includes the steps of performing a dynamic brightness control during the frame time, and adjusting the second average brightness according to a result of the dynamic brightness control.

As mentioned above, the video display driving method of the LCD according to the invention utilizes the exaggeration driving technology and the technology of intermittently driving the light emitting element of the backlight module. Thus, a preset-voltage signal and a post-set-voltage signal are sequentially written into a pixel during each frame time when the LCD is performing the dynamic brightness control, and the light emitting element of the backlight module is intermittently driven so that it presents the most suitable brightness variation and the brightness displayed on the display surface becomes adjustable. Thus, it is possible to effectively prevent the problem of poor quality display of the frame watched by the user while still allowing the brightness of the backlight source to be dynamically adjusted.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a cross-sectional side view of a conventional LCD;

FIG. 2A is a schematic illustration showing a driving voltage variation of a pixel in a video display driving method of the conventional LCD;

FIG. 2B is a schematic illustration showing a transmittance variation of a pixel on a display surface when the voltage of FIG. 2A is used to drive the pixel, wherein the solid line represents the liquid crystal of the pixel with longer response time and the dashed line represents the liquid crystal of the pixel with shorter response time;

FIG. 2C is a schematic illustration showing an intensity variation of a light source at a position of the pixel in the conventional backlight module;

FIG. 2D is a schematic illustration showing a brightness variation presented by the pixel on the display surface;

FIG. 3A is a schematic illustration showing a driving voltage variation of a pixel according to a video display driving method of a LCD according to a preferred embodiment of the invention;

FIG. 3B is a schematic illustration showing a transmittance variation of the pixel on a display surface when the voltage of FIG. 3A is used to drive the pixel;

FIG. 3C is a schematic illustration showing an intensity variation of a light source at a position of the pixel in the backlight module; and

FIG. 3D is a schematic illustration showing a brightness variation presented by the pixel on the display surface.

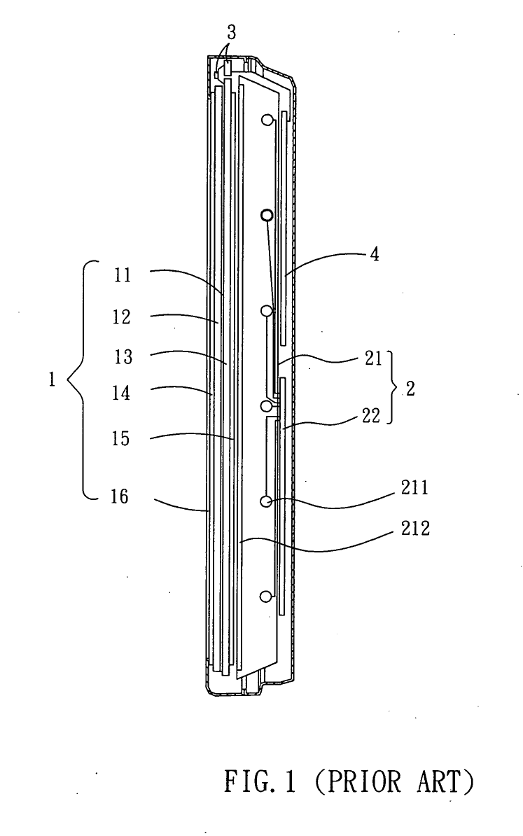

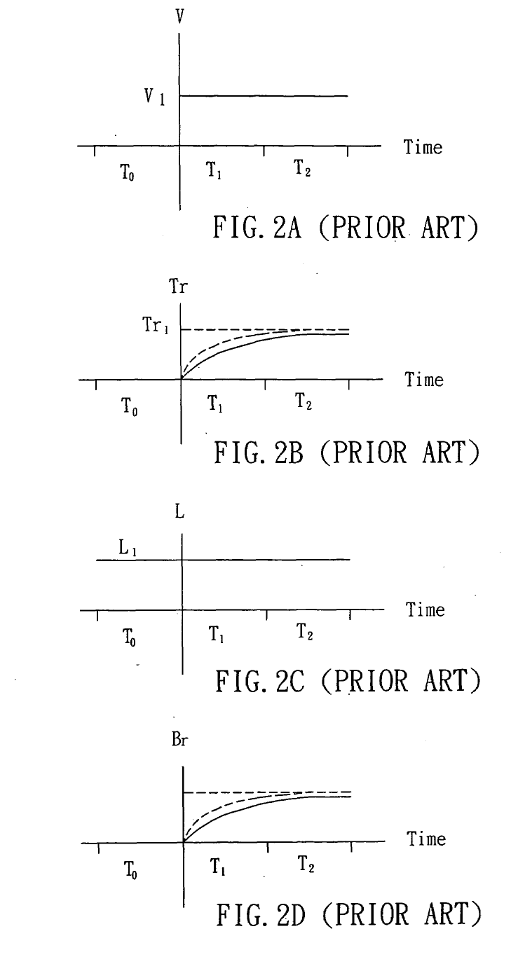

### DETAILED DESCRIPTION OF THE INVENTION

The present invention will be apparent from the following detailed description, which proceeds with reference to the accompanying drawings, wherein the same references relate to the same elements.

In this embodiment, the LCD may be a liquid crystal television or a typical display. For the sake of simplicity, the associated symbols of the LCD will not be changed. The LCD includes a liquid crystal display panel 1 and a backlight module 2. The liquid crystal display panel 1 has a plurality of pixels distributed over a display surface 16 of the liquid crystal display panel 1. In addition, the liquid crystal display panel 1 receives plural sets of video frame data. The backlight module 2 has at least one light emitting element 211, such as a light emitting diode, a cold cathode fluorescent lamp or a plane lamp, for generating a light source projected onto the display surface 16 of the liquid crystal display panel 1. In addition, a pixel is driven in this illustrated embodiment, and the driving voltages corresponding to three continuously successive sets of video frame data in the pixel are V₁′, V₃ and V₃, for example.

The video driving method of the LCD according to the preferred embodiment of the invention is to transform sets of video frame data, which are inputted from the outside, into sets of preset-voltage signals and sets of post-set-voltage signals to drive each of the pixels. In view of the sets of video frame data and in consideration of decreasing the power consumption, a dynamic brightness control (DBC) may be performed with respect to at least one set of video frame data according to the requirements of the display frame. The so-called dynamic brightness control adjusts the transmittance thereof to the maximum transmittance (e.g., the parameter value of 255) after the pixel having the maximum transmittance (e.g., the parameter value of 100) in one set of video frame data is computed. Thus, a ratio (255/100) may be obtained. Then, the transmittance of the other pixels is increased according to the ratio and the illumination intensity of each light emitting element 211 is decreased according to the ratio. Thus, the preset-voltage signal and the post-set-voltage signal corresponding to each set of video frame data are generated after the computation according to the dynamic brightness control.

In this embodiment, each set of video frame data corresponds to one set of preset-voltage signals and one set of post-set-voltage signals, and a preset-voltage signal of each set of preset-voltage signals also corresponds to one post-set-voltage signal of the set of post-set-voltage signals of the set of video frame data. In this embodiment, each set of preset-voltage signals is one set of exaggerated voltage signals corresponding to the set of post-set-voltage signals pertaining to each set of video frame data, and the preset-voltage signal and post-set-voltage signal pertaining to each set of video frame data are generated according to the result of the dynamic brightness control.

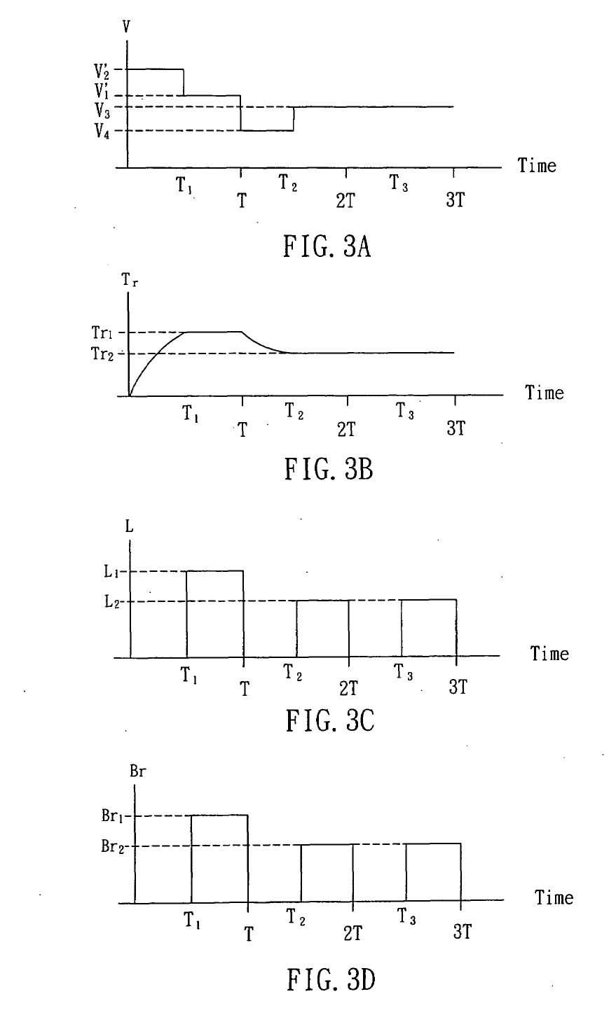

As shown in FIG. 3A, the video driving method is to sequentially write a preset-voltage signal of a first set of preset-voltage signals and a post-set-voltage signal of a first set of post-set-voltage signals into at least one pixel of the liquid crystal display panel during the first frame time T₁; to sequentially write a preset-voltage signal of a second set of preset-voltage signals and a post-set-voltage signal of a second set of post-set-voltage signals into the pixel of the liquid crystal display panel during the second frame time T₂; and to sequentially write a preset-voltage signal of a third set of preset-voltage signals and a post-set-voltage signal of a third set of post-set-voltage signals into the pixel of the liquid crystal display panel during the third frame time T₃. That is, the preset-voltage signal of the first set of preset-voltage signals is first written during the first frame time T₁, and the pixel is driven by the preset-voltage signal during the first T₁/2 time period. Then, the post-set-voltage signal of the first set of post-set-voltage signals is written, and the pixel is driven by the post-set-voltage signal during the last T₁/2 time period. In addition, the preset-voltage signal of the second set of preset-voltage signals is written during the second frame time T₂, and the pixel is driven by the preset-voltage signal during the first T₂/2 time. Then, the post-set-voltage signal of the second set of post-set-voltage signals is written, and the pixel is driven by the post-set-voltage signal during the last T₂/2 time. Also, the preset-voltage signal of the third set of preset-voltage signals is written during the third frame time T₃, and the pixel is driven by the preset-voltage signal during the first T₃/2 time. Then, the post-set-voltage signal of the third set of post-set-voltage signals is written, and the pixel is driven by the post-set-voltage signal during the last T₃/2 time.

In this example, the preset-voltage signal of the first set of preset-voltage signals is V₂′, the post-set-voltage signal of the first set of post-set-voltage signals is V₁′, the preset-voltage signal of the second set of preset-voltage signals is V₄, and the post-set-voltage signal of the second set of post-set-voltage signals, the preset-voltage signal of the third set of preset-voltage signals and the post-set-voltage signal of the third set of post-set-voltage signals are both equal to V₃. In this case, as shown in FIG. 3B, the transmittance of the pixel can almost reach the transmittance Tr₁ of the liquid crystal corresponding to the voltage signal V₁′ during the first T₁/2 time of the first frame time T₁, and can almost reach the transmittance Tr₂ of the liquid crystal corresponding to the voltage signal V₃ during the first T₂/2 time of the second frame time T₂. In addition, the time interval from the time when the preset image voltage signal is written into the pixel to the time when the post-set image voltage signal is written into the pixel is equal to one half of the frame time (T₁/2, T₂/2 or T₃/2). In other words, the video display driving method of the invention performs two writing operations during one frame time, and the pixel is driven by the exaggerated voltage signal during the front half time of the frame time. Herein, it is to be specified that the preset-voltage signal of the third set of preset-voltage signals and the post-set-voltage signal of the third set of post-set-voltage signals are equal to V₃. In other words, if the same voltage is to be written into the front and post frames of the same pixel, the voltage of the preset-voltage signal thereof (i.e., the exaggerated voltage signal) is equal to the voltage of the post-set-voltage signal thereof.

In addition, the pixel at the position in the display surface 16 described in the above example presents a first average brightness during the time corresponding to when the preset-voltage signal of each set of preset-voltage signals is written into the pixel, and presents a second average brightness greater than the first average brightness during the corresponding time when the post-set-voltage signal of each set of post-set-voltage signals is written into the pixel. In this embodiment, the video display driving method controls the illumination intensity of the light source of the light emitting element at the position closest to the pixel. That is, the video display driving method decreases the illumination intensity of at least one light emitting element of the backlight module during the corresponding time when the preset-voltage signal of each set of preset-voltage signals is written into the pixel, and increases the illumination intensity of at least one light emitting element of the backlight module during the corresponding time when the post-set-voltage signal of each set of post-set-voltage signals is written into the pixel. In addition, it is to be noted that the second average brightness is also controlled according to the result generated after the computation of the dynamic brightness control.

As shown in FIG. 3C, assume the illumination intensity of the light source of the light emitting element 211 is L₁, and the light intermittently illuminates with the duty cycle of 50% during the first frame time T₁. Thus, when the illumination intensity of the light source of the light emitting element 211 is L₂ and the light intermittently illuminates with the duty cycle of 50% during the second frame time T₂ and the third frame time T₃, the brightness presented at the pixel position in the display surface 16 is shown in FIG. 3D. Thus, in this example, because the sets of the video frame data are different, the first average brightness of each set is 0 after the dynamic brightness control, the second average brightness during the first frame time T₁ is Br₁, and the second average brightness during the second frame time T₂ and the third frame time T₃ is Br₂. In other words, when the dynamic brightness controls are performed according to different video frame data, the second average brightness of each set is adjusted according to the result of the dynamic brightness control. That is, different video frame data may have different second average brightness for display. In addition, each set of first average brightness Br₁ does not have to be equal to 0 in practice because a fraction of the brightness of the light source coming from the light emitting elements, which are not closest to the position of the pixel, still illuminates the position of the pixel.

In addition, it is to be noted that the backlight module is a bottom lighting backlight module in this embodiment. Of course, the backlight module may also be an edge lighting backlight module. In addition, the relationship of 1/50 seconds≧frame time≧ 1/120 seconds exists in this embodiment. Typically, the frame time is equal to 1/60 seconds.

In summary, the video display driving method of the LCD according to the invention utilizes the exaggeration driving technology and the technology of intermittently driving the light emitting element of the backlight module. Thus, a preset-voltage signal and a post-set-voltage signal are sequentially written into a pixel during each frame time when the LCD is performing the dynamic brightness control, and the light emitting element of the backlight module is intermittently driven so that it presents the most suitable brightness variation and the brightness displayed on the display surface becomes adjustable. Thus, it is possible to effectively prevent the problem of poor quality display of the frame watched by the user while still allowing the brightness of the backlight source to be dynamically adjusted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A video display driving method of a liquid crystal display (LCD), the LCD comprising a liquid crystal display panel and a backlight module, wherein the liquid crystal display panel has a plurality of pixels distributed over a display surface of the liquid crystal display panel, a light source of the backlight module is projected onto the display surface of the liquid crystal display panel, the liquid crystal display panel receives a plurality of sets of video frame data and transforms each of the sets of video frame data into a preset-voltage signal and a post-set-voltage signal for driving the pixels during a frame time, a light source brightness of the backlight module presents a first average brightness while the preset-voltage signal is written into at least one of the pixels and presents a second average brightness while the post-set-voltage signal is written into the pixel, and the second average brightness is greater than the first average brightness, the method comprising a step of:
performing a dynamic brightness control during the frame time; and
adjusting the second average brightness according to a result of the dynamic brightness control.

2. The method according to claim 1, wherein the post-set-voltage signal is adjusted according to the result of the dynamic brightness control during the frame time.

3. The method according to claim 1, wherein the preset-voltage signal pertaining to each of the sets of video frame data is a set of exaggerated voltage signals corresponding to the post-set-voltage signal pertaining to the video frame data.

4. The method according to claim 1, wherein the dynamic brightness control increases a transmittance of the pixel according to a ratio during the frame time, and decreases the second average brightness according to the ratio.

5. The method according to claim 4, wherein the transmittance of the pixel is controlled by the post-set-voltage signal.

6. The method according to claim 4, wherein the ratio is a ratio of the transmittance of the pixel to a maximum transmittance of the pixel.

7. The method according to claim 1, wherein the backlight module comprises a plurality of light emitting elements.

8. The method according to claim 7, wherein a brightness of at least one of the light emitting elements of the backlight module is decreased within the corresponding time when the preset-voltage signal is written into the pixel, and a brightness of the at least one of the light emitting elements of the backlight module is increased within the corresponding time when the post-set-voltage signal is written into the pixel.

9. The method according to claim 8, wherein the light emitting element whose brightness is increased is closest to the pixel.

10. The method according to claim 8, wherein the light emitting element whose brightness is decreased is closest to the pixel.

11. The method according to claim 7, wherein the light emitting elements of the backlight module are light-emitting diodes.

12. The method according to claim 7, wherein the light emitting elements of the backlight module are cold cathode fluorescent lamps (CCFLs).

13. The method according to claim 7, wherein the light emitting elements of the backlight module are plane lamps.

14. The method according to claim 1, wherein a time interval from a time period, in which the preset-voltage signal drives the pixel, to another time period, in which the post-set-voltage signal drives the pixel is substantially equal to one half of the frame time.

15. The method according to claim 1, wherein 1/50 seconds≧frame time≧ 1/120 seconds.

16. The method according to claim 1, wherein the backlight module is a bottom lighting backlight module.

17. The method according to claim 1, wherein the backlight module is an edge lighting backlight module.

18. The method according to claim 1, wherein the LCD is an LCD TV.
